(19) United States
(12) Patent Application Publication
(10) Pub. No.: US 2002/0008167 A1
(43) Pub. Date: Jan. 24, 2002

(54) Ground based remote sensing system

(76) Inventors: Julio A. Haberland, Tucson, AZ (US); Charles W. DeFer, Tucson, AZ (US); Peter M. Waller, Tucson, AZ (US); Christopher Y. Choi, Tucson, AZ (US); Paul D. Colaizzi, Casa Grande, AZ (US); Michael A. Kostrzewski, Tucson, AZ (US)

Correspondence Address: Stephen R. Christian, P. O. Box 1625, Idaho Falls, ID, 83415-3899, US

(21) Appl. No.: 09/841,750

(22) Filed: Apr. 24, 2001

Related U.S. Application Data
(60) Provisional application No. 60/199,230, filed on Apr. 24, 2000.

(51) Int. Cl. B05B 12/08; B05B 17/04

(52) U.S. Cl. 239/722; 239/63; 239/750; 239/752; 239/743; 239/264

(57) ABSTRACT

A ground based remote sensing system for use in conjunction with agricultural irrigation systems. The ground based remote sensing system includes a sensor package mounted to a carriage for movement along a track attached to the agricultural irrigation system. The track is triangular in cross section and includes springs between abutting sections so that travel of the carriage along the track will not be compromised by misalignment between the abutting sections. The sensor package is mounted to the carriage by a mount which acts to ensure that the sensor package remains in a predetermined orientation with respect to the agricultural crop from which data is being gathered. The mount also includes an inclinometer to permit correction of agricultural data gathering errors due to misalignment of the sensor package with respect to the agricultural crop. The ground based remote sensing system also includes conducting rails to transmit energy from a speed control circuit to the carriage motor. The output voltage, and thus the speed of the carriage, of the speed control circuit is variable. A traverse direction control circuit reverses the direction of the carriage as it reaches either end of the track so that the traverse direction control circuit and the speed control circuit collectively move the carriage continuously back and forth along the track. As the sensor package, mounted to the carriage, moves back and forth, it gathers agricultural crop data which can then be downloaded to a computer for processing and analysis.

### BACKGROUND OF THE INVENTION

1. Field of the Invention

The present invention relates generally to methods and devices for monitoring various physical parameters of an agricultural field. More particularly, embodiments of the present invention relate to a ground based remote sensing system for use in gathering agricultural crop data.

2. Prior State of the Art

There currently exists a variety of remote sensing systems used to gather agricultural crop data. Use of ground based remote sensing systems to obtain and continuously update agricultural crop data is well known. Ground based systems, in particular, provide tremendous advantages over aircraft, satellite, and other remote sensing systems. For example, cloud cover and other atmospheric interferences and disturbances frequently inhibit and/or prevent timely and effective gathering of agricultural crop data. It is generally acknowledged that a ground based remote sensing system whose sensors are in close proximity to the crop or ground to be monitored is not susceptible to these types of atmospheric interferences and is, in this regard at least, superior to aircraft and satellite based systems.

Another advantage presented by ground based sensing systems is that they tend to be substantially less expensive than aircraft or satellite based systems. In particular, the infrastructure for ground based systems is relatively simple technically, and employs readily available materials and components. On the other hand, aircraft and satellite based systems are logistically much more complex and typically employ relatively sophisticated technology, systems, and materials.

Ground based remote sensing systems are particularly attractive because they provide the farmer with a large measure of control over data gathering. Because ground based remote sensing systems are deployed in the farmer's fields, the farmer has ready access to the system and the data gathered thereby. Thus, the farmer is able to rapidly gather, analyze and update agricultural crop data. On the other hand, remote sensing systems such as those based upon satellite and air plane data gathering are typically not within the sole control of the farmer. Satellite based systems are particularly problematic. Specifically, the schedule by which the satellite revisits the agricultural crop and updates the data gathered therefrom is governed by such factors as satellite speed and movement of the earth, i.e., factors which the farmer cannot control. Thus, data gathering, and updating, by such systems is completely dictated by the satellite schedule, and not by the farmer. Further, if the satellite happens to pass by when clouds obscure the crop, the farmer is then forced to wait for data until the satellite again revisits the area. This is not a satisfactory arrangement where the farmer must make critical decisions based upon rapidly changing crop and/or soil conditions.

Satellite and aircraft based sensing systems are problematic for at least one other reason. In particular, because of their physical remoteness from the crop and/or soil from which data is being gathered, the resolution of the agricultural crop data and images gathered by those systems is poor.

While ground based remote sensing systems thus present a number of important advantages over aircraft or satellite based remote sensing systems, known ground based remote sensing systems suffer from a variety of significant shortcomings. First, many known ground based remote sensing systems employ a large number of sensors. Typically, the sensors are deployed along the entire length of a center pivot irrigation system or a linear move irrigation system. Because a large number of sensors are required with these types of ground based remote sensing systems, the expense associated with such systems accordingly is increased significantly. Not only is the expense increased by the presence of multiple sensors, but the logistics and design considerations, and thus the cost, involved in connecting a plurality of sensors are likewise increased as well. Furthermore, because each of the sensors represents a potential failure point, costs associated with maintaining those sensors and the system as a whole are necessarily increased.

In addition to the inherent, system-wide, disadvantages typically encountered in known ground based remote sensing systems, the component parts of known ground based remote sensing systems present problems as well.

As indicated earlier, many known ground based remote sensing systems employ a plurality of sensors, the sensors being disposed at regular intervals along a center pivot or linear move irrigation arm. However, other systems employ a single sensor package that travels along the irrigation arm on a track. Known tracks typically comprise two continuous track rails which are joined together at intervals. The track rails are typically constructed of angle iron or the like. This type of construction introduces a number of problems.

First, it is well known that linear move irrigation systems and center pivot irrigation systems tend to shake and vibrate as they travel over the uneven ground typically found in agricultural fields. Furthermore, those irrigation systems are also subject to thermal stresses as the cold water flows through the piping system and as the piping system absorbs heat and energy from the sun. The irrigation systems are thus in a constant dynamic state, moving and flexing under these influences. However, the typical track system employs no structure or device which permits it to readily accommodate the stresses and movement to which the irrigation system is subjected. Accordingly, the tracks employed by known ground based remote sensing systems tend to deform and otherwise expand or contract in such a way as to disrupt, or prevent, the gathering of agricultural crop data by the sensors that travel along the track. In more extreme cases, the tracks may fracture after repeated exposure to thermal and other stresses.

Another problem associated with known track systems used by ground based remote sensing systems is that the two rail type tracks are generally ineffective in preventing vertical excursions of sensor packages suspended beneath the tracks. Because of the uneven ground over which irrigation systems typically travel, the sensor package suspended from the track thus described is thus subjected to sudden and violent vertical excursions. Movement of the sensor package in this manner can disrupt and/or prevent the gathering of agricultural crop data by the sensors. In more extreme cases, the sensor package is damaged and requires repair or replacement. As suggested above, farmers often require updated agricultural crop data on a frequent basis, due to ever-changing weather and crop conditions. Thus, sensor package down time, as may result from inadequate track designs, seriously compromises the ability of the farmer to effectively manage the agricultural crops.

Problems with known ground based remote sensing systems are not limited solely to the tracks along which the sensors are transported, however. The mounts by which the sensors are secured in position are critical as the sensors must remain constantly aligned with the agricultural crop or soil so that complete and accurate agricultural crop data may be reliably gathered. However, the typical mounts and/or mounting systems by which the sensors are secured in position present at least three significant problems.

First, some known sensor mounts are unnecessarily complex. For example, some of these mounts comprise two different parts, an alignment portion and a mount by which the alignment portion is attached to the carriage. As a result of their complexity, these types of devices are likely to be more expensive to manufacture and maintain. Furthermore, some of these known mounts also incorporate servo motors and computer controls wherein the computer controls the positioning of the sensor by sending signals to the servo motors which in turn adjust the sensor in a direction consistent with the signals sent by the computer. Clearly, the addition of servo motors and computer controls further complicates these types of devices and may well result in increased production costs and/or maintenance costs.

Another problem with known mounts, as suggested above, is that these devices are not self-adjusting. Rather, these devices rely on computer controls or the like to place the sensors in the desired position and/or orientation with regard to the agricultural crop and/or field.

Last, known mounts do not incorporate any type of error compensating feature. In particular, if sensors secured by known sensor mounts are out of position, whether because of inaccurate computer control data or because thermal or other physical conditions have caused displacement of the sensor, there is no way to detect and/or compensate for data errors induced by the misalignment of the sensors. Because the farmer is required to make important decision based on the data gathered, errors such as these are unacceptable.

Finally, the control systems which are used to transport sensors along the tracks of known ground based remote sensing systems present some problems as well. For example, currently available power supply transformers for variable speed, dualdirectional motors, such as are required for transverse movement of the sensors, typically require that direction of travel, speed, starting, and stopping be manually controlled. This is problematic where mapping, i.e., with the sensors, occurs at night or at other times and/or locations when it is not feasible to have an operator present to effect manual control.

In view of the foregoing problems with known ground based remote sensing systems, such as those typically utilized with linear move and/or center pivot irrigation systems, what is needed is an improved ground based remote sensing system. Specifically, the ground based remote sensing system should be constructed so as to minimize physical and technical complexity, and therefore, construction and maintenance costs associated with the system. Further, the ground based remote sensing system should be constructed in such a manner so as to ensure that agricultural crop data collection by the sensors is not interrupted or otherwise compromised by outside conditions and influences including, but not limited to, thermal stresses, and movement of the ground based remote sensing system through agricultural fields. Also, the ground based remote sensing system should ensure that the sensor or sensors remain in operative communication with the agricultural crop and/or soil during the entire time that agricultural crop data is being gathered by the system. Finally, the ground based remote sensing system should ensure that the sensor or sensors can be reliably and consistently aligned and re-aligned with respect to the agricultural crops and/or the soil from which agricultural crop data is being collected.

### BRIEF SUMMARY AND OBJECTS OF THE INVENTION

The present invention has been developed in response to the current state of the art, and in particular, in response to these and other problems and needs that have not been fully or completely solved by currently available ground based remote sensing systems. Thus, it is an overall object of an embodiment of the present invention to provide a ground based remote sensing system that resolves at least the problems identified herein.

It is another object of the present invention to provide a ground based remote sensing system adapted for use in conjunction with field irrigation systems.

It is also an object of the present invention to provide a ground based remote sensing system that is relatively simple in design and operation.

Further, it is an object of the present invention to provide a ground based remote sensing system which will help ensure that agricultural crop data collection is not interrupted or otherwise compromised by factors such as thermal stresses, movement, or the like.

Similarly, it is an object of the present invention to provide a ground based remote sensing system which will reliably maintain operative communication with the agricultural crop and/or soil.

Finally, it is an object of the present invention to provide a ground based remote sensing system that can quickly, reliably, and automatically gather and update agricultural crop data.

In summary, the foregoing and other objects, advantages, and features are achieved with an improved ground based remote sensing system for use in gathering and updating agricultural crop data. Embodiments of the present invention are particularly suitable for use with linear move irrigation systems, and the like.

In a preferred embodiment, the ground based remote sensing system includes a track, a carriage, a plurality of sensors mounted to the carriage, and a control system for transporting the carriage along the track. Preferably, the track of the inventive ground based remote sensing system is mounted to and supported by the main overhead irrigation pipe of a linear move sprinkling system so that the axis of the track is substantially transverse to the path of travel of the linear move irrigation system.

In one embodiment, the track comprises three rails arranged in a triangular configuration. Preferably, the carriage is mounted about the three rails in such a manner that vertical movement of the carriage is precluded and movement of the carriage is confined solely to a lateral direction along the length of the rails which comprise the track. Preferably, contiguous rails of the track are spaced slightly apart from each other and include a joint to permit expansion and contraction of the track in response to thermal stresses and motion of the irrigation system to which the track is mounted.

In a preferred embodiment, two additional copper pipes are mounted parallel to the rails of the track and transmit electricity to a motor of the carriage via electrically conductive wheels located on the carriage. The ground based remote sensing system preferably includes a direction control circuit and a speed control circuit in operative communication with the carriage motor so as to move the carriage substantially continuously, and automatically, back and forth along the track as the linear move irrigation pipe moves down the field.

The ground based remote sensing system preferably includes a mount for the sensors to ensure that the sensors are securely mounted to the carriage and remain in operative communication with the agricultural crop and/or soil from which data is being gathered. In a preferred embodiment, the ground based field remote sensing system includes a data logger so as to record agricultural crop data acquired by the sensors and/or the camera.

These and other objects, features, and advantages of the present invention will become more fully apparent from the following description and appended claims, or may be learned by the practice of the invention as set forth hereinafter.

### BRIEF DESCRIPTION OF THE DRAWINGS

In order to more fully understand the manner in which the above-recited and other advantages and objects of the invention are obtained, a more particular description of the invention will be rendered by references to specific embodiments thereof which are illustrated in the appended drawings. Understanding that these drawings depict only typical embodiments of the invention and are not therefore to be considered to be limiting of its scope, the invention and its presently understood best mode for making and using the same will be described and explained with additional specificity and detail through the use of the accompanying drawings in which:

FIG. 1A is a perspective view indicating one embodiment of a track attached to a linear move irrigation system:

FIG. 1B is a cross-section view of one embodiment of a track and indicating the relationship between the track and one embodiment of a carriage adapted for travel along the track;

FIG. 1C is a side view of the carriage mounted to the track;

FIG. 2 is a block wiring diagram of one embodiment of a system to collect and process agricultural crop data, and indicating the functional relationships between a sensor package, a data logger, a global positioning system, a computer, an optical proximity sensor, and reflective straps;

FIG. 3 is a schematic drawing of one embodiment of a mount for use with sensors in agricultural applications, and generally indicates the relationships between the mount, a sensor package, and the carriage;

FIG. 4 is a wiring diagram indicating one embodiment of a circuit adapted to automatically reverse the direction of the carriage as it reaches either end of the track;

FIG. 5 is a wiring diagram of one embodiment of a circuit adapted to provide power to the rails so as to control the speed of the carriage as it travels back and forth along the track;

FIG. 6 depicts an alternative embodiment of a track in accordance with the teachings of the present invention; and

FIG. 7 indicates additional details of an alternative embodiment of a track and carriage in accordance with the teachings of the present invention.

### DETAILED DESCRIPTION OF THE PREFERRED EMBODIMENTS

Reference will now be made to figures wherein like structures will be provided with like reference designations. It is to be understood that the drawings are diagrammatic and schematic representations of various embodiments of the invention, and are not to be construed as limiting the scope of the present invention.

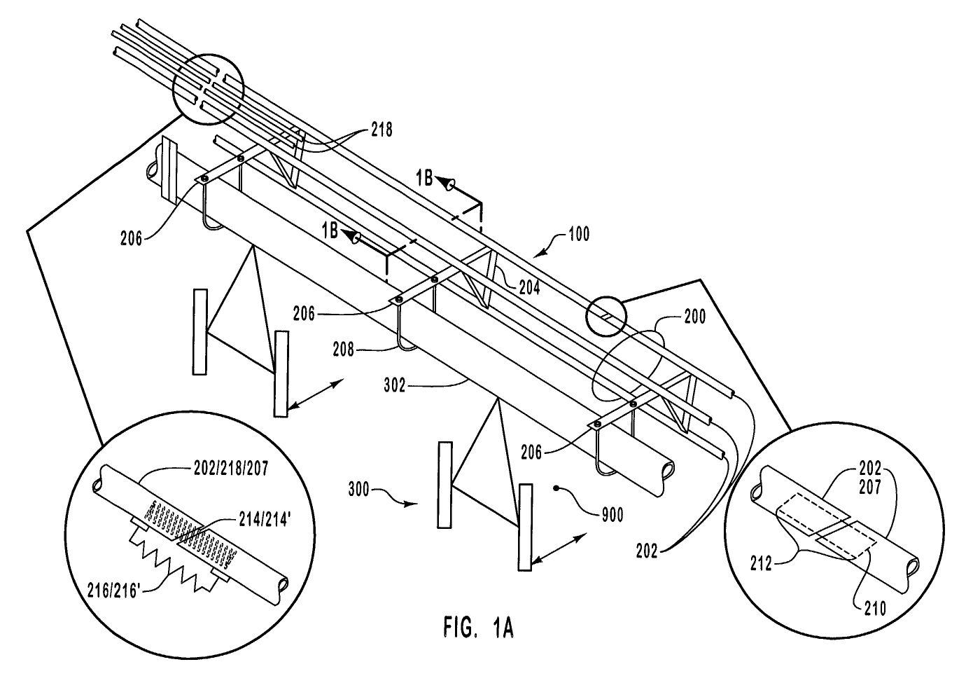

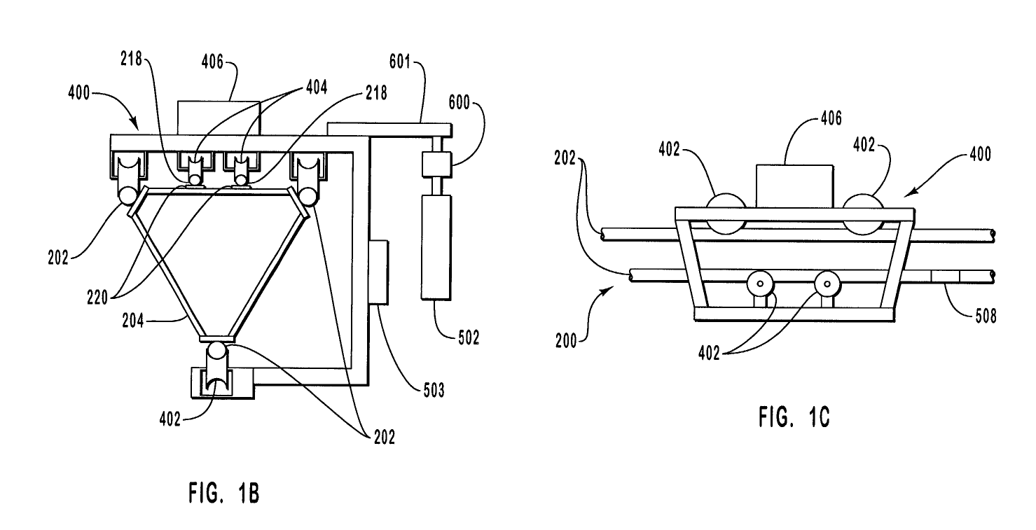

In general, the present invention relates to an improved ground based remote sensing system for use in gathering agricultural crop data. As used herein, ‘agricultural crop data’ includes insect data, plant data, soil data, or other types of data including, but not limited to, moisture data. Further, as used herein, a ‘remote sensing system’ refers generally to systems which employ sensors remote or removed from the crop or field being monitored, as opposed to systems employing sensors disposed directly in the field or crop. Ground based remote sensing systems are those wherein the sensors are attached to a structure which moves in relatively close proximity to the ground. FIGS. 1a through 5 indicate embodiments of a ground based remote sensing system conforming to the teachings of the invention.

Reference is first made to FIG. 1A, which depicts features of one embodiment of the present invention. The ground based remote sensing system is indicated generally as 100. Ground based remote sensing system 100 includes a track 200 secured to irrigation system 300. In one embodiment, irrigation system 300 comprises a linear move irrigation system or the like, configured for substantially linear movement through agricultural field 900. However, it is contemplated that ground based remote sensing system 100 can profitably be employed with a wide variety of irrigation systems 300, including but not limited to center pivot irrigation systems, or the like. Note that a variety of means may be employed to perform the function of irrigation system 300, as disclosed herein. Irrigation system 300 is on example of a means for transporting track 200 through an agricultural field. It should thus be understood that irrigation system 300 simply represents one embodiment of structure capable of performing this function and should not be construed as limiting the scope of the present invention in any way. Further, it is contemplated that alternative embodiments of ground based remote sensing system 100 may be transported throughout agricultural field 900 by agricultural machinery including, but not limited to, tractors and the like.

As further indicated in FIG. 1A, track 200 comprises three rails 202 arranged in a triangular configuration, with the apex of the triangle pointing downwards to the ground. Note that this invention contemplates as within its scope any other material that would provide the functionality of rails 202 as described herein. However, it is contemplated that other structures besides tubes may profitably be employed to provide the functionality of track 200 as described herein. In particular, this invention contemplates as within its scope tracks comprising a variety of different structural shapes, including but not necessarily limited to, channels, or the like.

Track 200 further comprises a plurality of trusses 204 spaced at regular intervals so as to provide support for rails 202. Each truss 204 is secured to a support arm 206. Support arms 206 are adjustable in length so as to permit movement of track 200 further away from, or closer to, irrigation system 300.

With continuing reference to FIG. 1A, support arms 206 are preferably constructed of one inch square steel tubing. However, any other size, material and/or geometry that would provide the functionality of support arms 206 as described herein is contemplated as being within the scope of the present invention. Support arms 206, are in turn attached to main overhead pipe 302 of irrigation system 300 by means of U-bolts 208 or the like. The positioning of U-bolts 208 may desirably be adjusted so as to lower or raise track 200 relative to the ground. Any other attachment device or method that would provide the functionality of U-bolts 208 is contemplated as being within the scope of the present invention. Alternatively, track 200 could be mounted above main overhead pipe 302 of irrigation system 300. This could be accomplished in a variety of ways, including, but not limited to, mounting track 200 either directly to main overhead pipe 302, or indirectly by the use of support arms 206, or the like.

Abutting sections of rails 202 are connected to each other by couplers 210, as indicated in FIG. 1A. Couplers 210 slide within rails 202 in order to permit relative movement of abutting sections of rails 202 without compromising the effectiveness or mobility of carriage 400 (see FIGS. 1B and 1C). Movement of rails 202 may be caused by a variety of factors including, but not limited to, thermal expansion and contraction, and movement of irrigation system 300. Further, rails 202 are subject to temporary deformation as a result of changes in the water load inside main overhead pipe 302 of irrigation system 300. This temporary deformation can likewise cause relative movement between rails 202. Abutting sections of rails 202 are prevented from moving completely apart by elastic strap 212. In one embodiment, couplers 210 comprise metal tubing or the like. However, the present invention contemplates as within its scope any other structure and/or device that would provide the functionality of couplers 210 as disclosed herein.

In a preferred embodiment, track 200 is configured for use with a linear move irrigation system 300 comprising two or more abutting spans. In order to accommodate angular offsets, and relative movement, between the abutting spans of irrigation system 300, connectors 214 are inserted into abutting rails 202, as indicated in FIG. 1A. Connectors 214 preferably comprise an elastic and flexible material and/or structure that serves to allow track 200 to flex and thereby accommodate relative angular movement between abutting spans of irrigation system 300 move as irrigation system 300 moves across the uneven terrain often encountered in fields such as agricultural field 900. Connectors 214, while elastic and flexible, are also sufficiently strong to support the weight of carriage 400. Further, connectors 214 have substantially the same circumference as the inside of rails 214 and thus will not compromise the mobility of carriage 400 as it travels along track 200. Finally, because connectors 214 are disposed inside rails 202, they are also able to readily accommodate relative horizontal movement between the abutting rails.

In a preferred embodiment, connectors 214 comprise metal springs or the like. However, the present invention contemplates as within its scope any other structure or device that would provide the functionality of connectors 214 as disclosed herein.

With continuing reference now to FIG. 1A, jumper wire 216, or the like, is used to provide electrical continuity between abutting rails 202. In like fashion, connector 214′ and jumper wire 216′ are used to connect abutting conducting rails 218. Connector 214′ possesses substantially the same functionality, as disclosed herein, as connector 214. However, connector 214′ is also electrically conductive so as to facilitate transmission of power along conducting rails 218.

With reference now to FIGS. 1B and 1C, a carriage, indicated generally as 400, is mounted for linear movement along track 200. Carriage 400 is preferably constructed of square steel tubing or the like, but other types and shapes of materials that would provide the functionality of carriage 400, as described herein, are contemplated as being within the scope of the present invention.

Carriage 400 preferably comprises six wheels 402, two of wheels 402 being in contact with each rail 202. In a preferred embodiment, wheels 402 comprise a circumferential semi-circular groove adapted to receive a portion of the diameter of rails 202 so as to ensure reliable and substantial contact therebetween. Carriage 400 further comprises conducting wheels 404 which preferably comprise copper or the like. Conducting wheels 404 are in contact with conducting rails 218, conducting wheels 404 comprising a circumferential semi-circular groove adapted to receive a portion of the diameter of conducting rails 218 so as to ensure substantial contact therebetween. Conducting rails 218 are mounted substantially parallel to rails 202, so as to transmit power from conducting rails 218 to carriage motor 406. Conducting rails 218 are electrically isolated from rails 202 by mechanical vibration isolators 220. Carriage motor 406 is in operative communication with at least two wheels 402 so as to drive wheels 402 in response to transmission of power to carriage motor 406. The circuit by which power is provided to conducting rails 218 is discussed in greater detail below.

Note that a variety of means may be employed to perform the function of moving transmitting power to carriage motor 406. Conducting rails 218 simply comprise an example of a means for performing that function. It should be understood that the embodiments of conducting rails 218 are presented solely by way of example and should not be construed as limiting the scope of the present invention in any way.

In an alternative embodiment, one of rails 202 is electrically isolated from the remaining two rails 202. The remaining two rails 202 are then used to transmit power to carriage motor 406, one rail 202 being the “hot” rail and the other rail 202 functioning as the ground, thereby foreclosing the need for use of conducting rails 218.

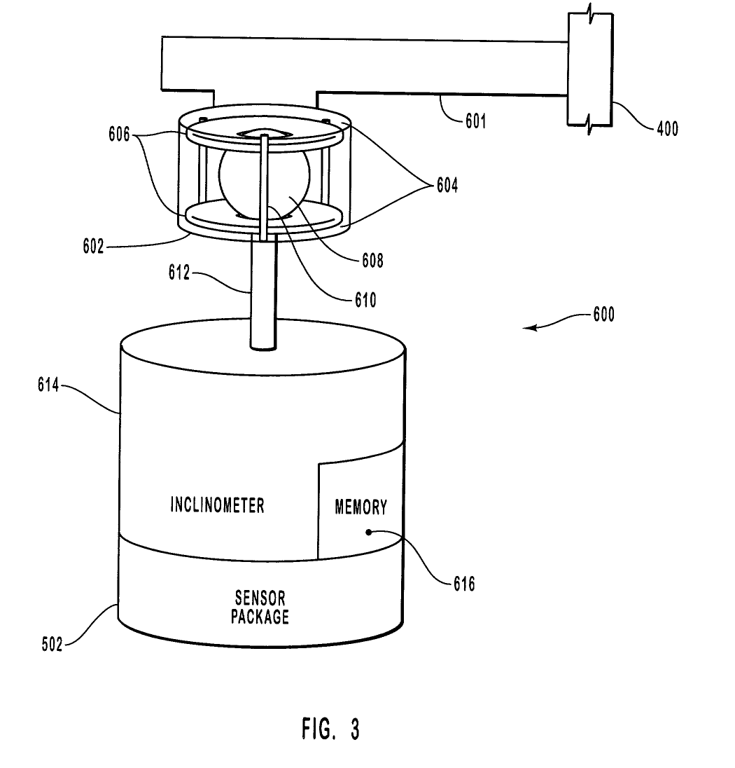

As indicated generally in FIG. 1B, a sensor package 502 and data logger 503 are mounted to carriage 400. In particular, sensor package 502 is attached to mount 600 which, in turn, is removably secured to boom 601 (see also FIG. 3, discussed below) depending from carriage 400. Boom 601 serves to remove sensor package 502 a predetermined distance away from carriage 400 so as to prevent the structure of irrigation system 300 from compromising accurate data gathering by sensor package 502. Specific details regarding the construction and operation of mount 600, sensor package 502 and data logger 503 are provided below.

In general however, sensor package 502 acquires agricultural crop data as carriage 400 travels back and forth along an axis defined by track 200. Substantially simultaneously with the back and forth motion of carriage 400 along the axis defined by track 200, irrigation system 300 is advancing across the agricultural field along a predetermined pathway so that the collective movements of sensor package 502, as viewed from above, describe a generally wave-like form. In one embodiment, track 200 is substantially transverse to the predetermined pathway of irrigation system 300.

As sensor package 502 acquires agricultural crop data, that data is fed to data logger 503 which is in operative communication with sensor package 502. Data logger 503 collects and stores the agricultural crop data until that data can be downloaded. The types of agricultural crop data that may be acquired by sensor package 502 are virtually unlimited. As contemplated herein, ‘agricultural crop data’ includes, but is not limited to, both plant and soil data such as plant and/or soil nitrogen content, plant and/or soil moisture content, insect infestation level, fungus and disease distribution, or the like. Further, ‘agricultural field’ as contemplated herein includes the soil and/or the crop(s). Accordingly, the gathering of agricultural crop data from an ‘agricultural field’ refers to gathering soil and/or crop data.

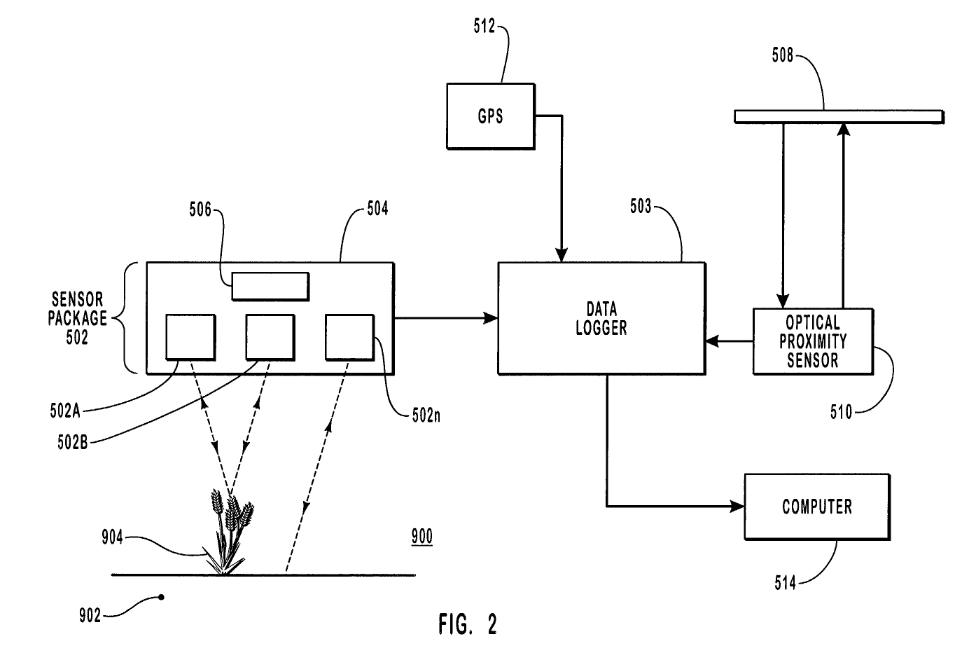

With reference now to FIG. 2, the operation of sensor package 502 and data logger 503 is described in further detail. In one embodiment, sensor package 502 takes reflectance measurements of one square meter field areas. Alternatively, sensor package 502 may take emittance measurements, or may employ various combinations of emittance and reflectance measurements as required to suit a particular application. To this end, sensor package 502 preferably comprises a plurality of sensors capable of emitting and/or receiving energy wavelengths ranging from blue to thermal infrared. Specifically, the energy transmitted by sensor package 502, or transmitted by external sources including, but not limited to, incoming solar energy, impinges on soil 902 and/or crop 904 of agricultural field 900. In one embodiment, agricultural crop data gathered by sensor package 502 is determined by comparing the energy of the wavelength thus transmitted with the energy of the wavelength reflected and/or emitted by soil 902 and/or crop 904. Note that sensor package 502 may include a variety of other types and combinations of sensors, including, but not limited to, cameras, sensors employing radio detecting and ranging (RADAR) functionality, sensors employing light detecting and ranging (LIDAR) functionality, and the like.

One embodiment of sensor package 502 includes sensors sensitive to wavelengths of 460, 520, 630, 660, 710, 830, 880, and 1,640 nanometers, these sensors being indicated generally as 502A, 502B, and 502n. Sensors 502A, 502B, and 502n are preferably embedded in aluminum structure 504 so that the thermal stability of sensors 502A, 502B, and 502n may be maintained. In one embodiment, aluminum structure 504 comprises an aluminum plate housed in an aluminum cylinder. Thermal stability is an important consideration as a lack thereof may impart errors to the readings taken by sensors 502A, 502B, and 502n. Note that this invention contemplates as within its scope any other materials, or combinations thereof, that would provide the functionality of aluminum as described herein.

Sensor package 502 preferably also includes an upward-looking sensor 506 that detects the intensity of solar radiation and is thus useful to calibrate sensors 502A, 502B, and 502n so as to compensate for any effect imposed thereon by solar radiation or similar influences.

One embodiment of the present invention comprises a plurality of reflective straps 508, or the like. Reflective straps 508 are located at regular intervals, preferably about one meter, along rails 202 so that as optical proximity sensor 510, mounted to carriage 400, passes over reflective straps 508, optical proximity sensor 510 triggers data logger 503 to record the agricultural crop data acquired by sensor package 502 at that instant. Note that this invention contemplates as within its scope any other device or devices which would provide the functionality of optical proximity sensor 510 and reflective straps 508 as disclosed herein.

In a preferred embodiment, a global positioning system (GPS) 512 is in operative communication with data logger 503 so that as data is acquired by sensor package 502 and recorded by data logger 503, data logger 503 is also able to aggregate agricultural crop and/or field data with location data provided by GPS 512. The aggregated data is then downloaded to computer 514 which processes the data so as to determine the precise location from which the data logged originated. In one embodiment of the present invention, computer 514 uses the agricultural crop data and the data provided by GPS 512 to construct a map of one or more attributes of the agricultural crop or field. For example, a map indicating the distribution and concentration of nitrogen, or even insects, in a particular crop could be developed. Because the aggregated data is, or may be, collected with every pass of irrigation system 300 (not shown) over agricultural field 900, the farmer has access to substantially realtime information regarding the condition of the agricultural crop and/or soil.

Turning now to FIG. 3, one embodiment of structure for mounting sensor package 502 to a mobile structure, such as carriage 400, is indicated in detail. The mount is indicated generally as 600. Mount 600 includes a body 602 which is suspended from boom 601. As previously indicated, boom 601 is secured to carriage 400. By suspending sensor package 502 out and away from irrigation system 300, boom 601 serves to substantially prevent irrigation system 300 structures from interfering with data gathering by sensor package 502.

In an alternative embodiment, boom 601 is pivotally attached to carriage 400 so that sensor package 502 can be readily positioned as required to suit operational requirements and/or environmental conditions. In another embodiment, a plurality of booms 601 are employed at various orientations with respect to irrigation system 300, each boom 601 having a sensor package 502 depending therefrom.

With continuing reference to FIG. 3, mounted inside body 602 is a rotative couple, indicated generally as 604. Rotative couple 604 includes two seats 606. In one embodiment, seats 606 comprise rings made of Teflon, or the like. However, other materials such as plastics are contemplated as being within the scope of the present invention. Interposed between seats 606 is ball 608. The compression exerted by seats 606 on ball 608 can be readily adjusted by means of adjustment screws 610 which act to move seats 606 closer together or further apart. Sensor package 502 is connected to ball 608 by connecting rod 612 so that in operation, the movement of sensor package 502 can be controlled by adjusting the compressive force exerted on ball 608 by seats 606. Seats 606 thus act as brakes on the motion of ball 608 and thereby control the sensitivity of ball 608 to motion imposed by outside influences. This desirable effect is achieved with respect to sensor package 502 as well because, as previously noted, sensor package 502 is connected to ball 608. As suggested above, adjustment screws 610 may desirably be rotated to increase or decrease the sensitivity of ball 608, as required by operating conditions. Note that the present invention contemplates within its scope any other structure, devices, or combinations thereof that would provide the functionality of rotative couple 604 as disclosed herein. Finally, note that in some cases, mount 600 has been effective in facilitating a relative decrease in angular deflection of sensor package 502 by as much as 70%.

Mount 600 further comprises an inclinometer 614 mounted to sensor package 502. inclinometer 614 records in memory 616 sensor package 502 alignment data taken at each agricultural crop data reading position. The sensor package 502 alignment data recorded in memory 616 can then be used to make corrections to agricultural crop data recorded by sensor package 502. This invention contemplates within its scope any other structure and/or devices having the functionality of inclinometer 614 and memory 616 as disclosed herein.

To briefly summarize then, mount 600 incorporates at least two valuable features. First, mount 600 is effective in substantially minimizing misalignment of sensor package 502 during operation. Further, in those cases where misalignment of sensor package 502 is unavoidable due to extreme environmental conditions, operating conditions, or other outside influences, mount 600 provides the capability of detecting misalignment of sensor package 502 and correcting agricultural crop data gathered by sensor package 502 when sensor package 502 is misaligned.

The aforementioned features are particularly valuable when sensor package 502 comprises one or more sensors that must be disposed in a substantially vertical position in order to perform properly, such as when sensor package 502 is performing reflectance type data collection. Mount 600 thus cooperates with boom 601 to ensure that sensor package 502 is disposed in such a manner as to prevent irrigation system 300 from interfering with data gathering by sensor package 502 and to ensure that sensor package 502 is optimally aligned with agricultural field 900 and/or soil 902 and/or crop 904.

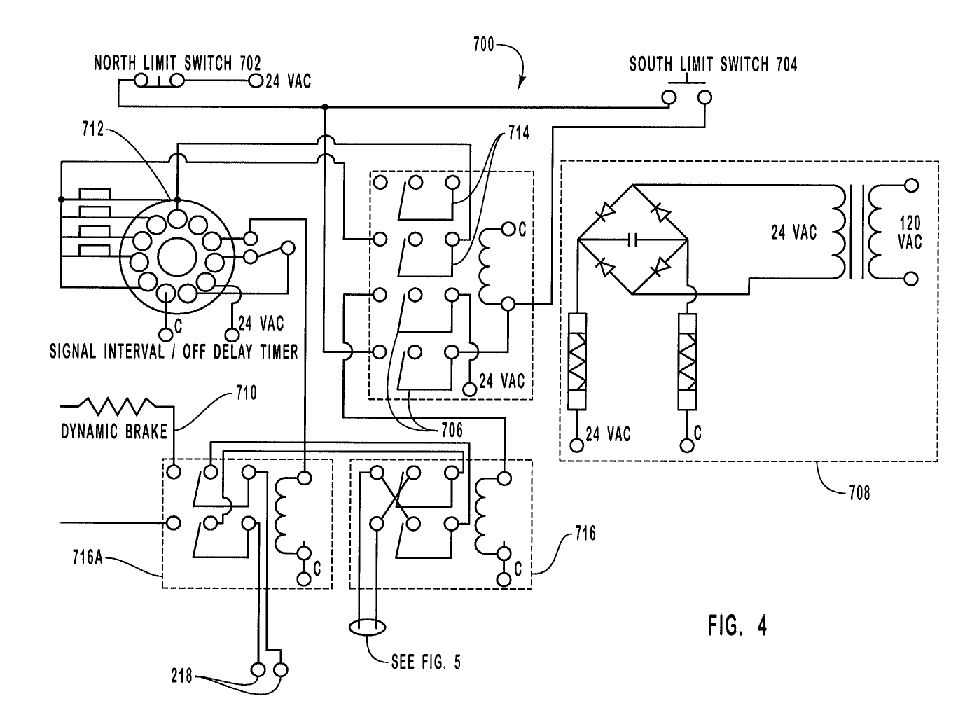

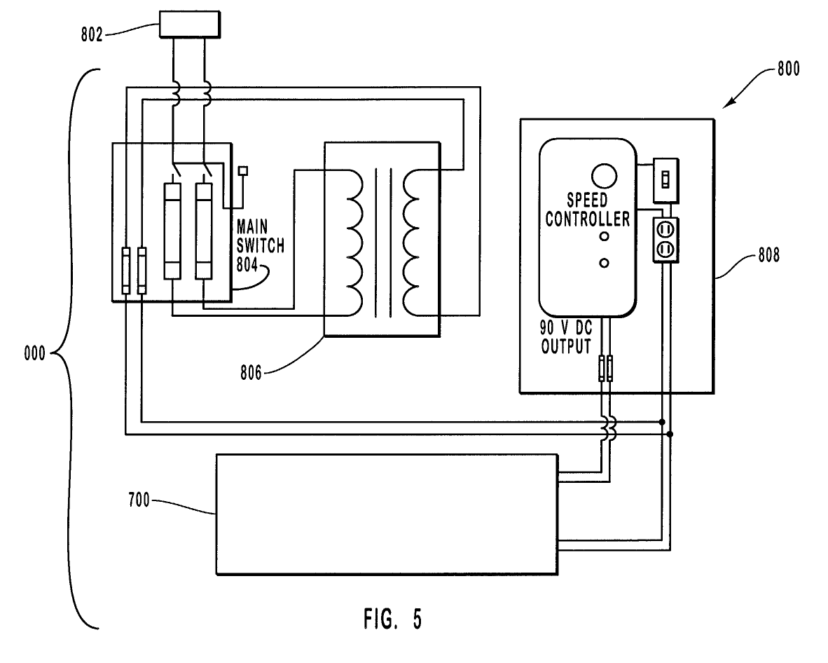

Details of a control system 1000 for moving carriage 400 back and forth on track 200 are indicated in FIGS. 4 and 5. The control system 1000 comprises a traverse direction control circuit, indicated generally as 700 in FIG. 4, and a speed control circuit 800 (FIG. 5). Note that a variety of means may be employed to perform the function of moving carriage 400 (not shown) along track 200 (not shown). Control system 1000 simply comprises an example of a means for performing that function. It should be understood that the embodiments of control system 1000 are presented solely by way of example and should not be construed as limiting the scope of the present invention in any way.

As indicated in FIG. 4, traverse direction control circuit 700 includes a north limit switch 702 and south limit switch 704. In a preferred embodiment, north limit switch 702 is normally closed and south limit switch 704 is normally open.

Note that a variety of means may be employed to perform the function of north limit switch 702 and south limit switch 704. North limit switch 702 and south limit switch 704 simply comprise an example of a means for performing that function. It should be understood that the embodiments of north limit switch 702 and south limit switch 704 are presented solely by way of example and should not be construed as limiting the scope of the present invention in any way.

North limit switch 702 and south limit switch 704 are mounted, respectively, at each end of track 200 (not shown) and are in electrical communication with powered relays 706. Energy to powered relays 706 is provided by relay power circuit 708. In one embodiment, relay power circuit 708 provides 24 volt direct current (DC) power. Traverse direction control circuit 700 further includes dynamic brake 710 so that when carriage 400 operably contacts either north limit switch 702 or south limit switch 704, dynamic brake 710 is activated in traverse direction control circuit 700. The use of limit switches in this application is particularly advantageous because the limit switches, upon coming into operable contact with carriage 400, automatically generate a signal indicating that the carriage must stop and reverse direction. Thus, no manual intervention is required to stop the carriage and then reverse its direction along track 200. In operation, dynamic brake 710 serves to stop motion of carriage 400 by cutting off the power supply to rails 218 for a user specified time interval controlled by signal interval/off delay timer 712.

Signal interval/off delay timer 712 is connected to powered relay 716A so that when the user specified time interval has elapsed, dynamic brake 710 is deactivated, and power is provided to conducting rails 218. At about the same time, the polarity of the power provided to conducting rails 218 is automatically reversed by power relay 716 so that when dynamic brake 710 is deactivated, carriage 400 (not shown) will then reverse its direction of travel.

In one embodiment, dynamic brake 710 comprises a 120 ohm, 25 watt resistor, or the like, across conducting rails 218. The time delay in the action of dynamic brake 710 introduced by signal interval/off delay timer 712 is advantageous for at least two reasons: first, the time delay allows carriage 400 to come to a complete stop before changing directions; and, second, the time delay effectively inserts a noticeable and reliable time interval between data acquisition points, indicating the point in the agricultural crop data file where carriage 400 changed direction.

Traverse direction control circuit 700 thus automatically reverses the direction of carriage 400 (not shown) and inserts a user specified time interval between the time that motion of carriage 400 (not shown) ceases and the time that motion in the opposite direction commences. In one embodiment, the user specified time interval is about 3 seconds so that carriage 400 (not shown) moves substantially continuously back and forth along conducting rails 218. The time interval for which dynamic brake 710 is activated is controlled by setting signal interval/off delay timer 712. One signal interval/off delay timer that would provide functionality described herein is Omron model H3CA-A SPDT

As further indicated in FIG. 4, traverse direction control circuit 700 comprises a power relay 716. Energy to the poles of power relays 716 and 716A is provided by speed control circuit 800, the details of which are discussed below. Power relay 716 is in communication with power relay 716A, and power relay 716A serves to provide 90 volt DC power to conducting rails 218, when dynamic brake 710 is disengaged, and thence to carriage motor 406 (not shown). In a preferred embodiment, carriage motor 406 (not shown) is a 90 volt DC gear motor, 180 RPM, ¼ horse power, permanent magnet type. As suggested above, signal interval/off delay timer 712 cooperates with dynamic brake 710 to prevent, for a user specified time interval, power relay 716A from providing power to conducting rails 218, when dynamic brake 710 is engaged.

Details of speed control circuit 800 are provided in FIG. 5. In particular, speed control circuit 800 comprises an alternating current (AC) input 802. In one embodiment, AC input 802 provides 480 volts. Flow of power from AC input 802 is controlled by main switch 804 which is further in communication with transformer 806. In one embodiment, transformer 806 comprises a 2 kVA transformer and serves to step down the 480 volt AC provided by AC input 802 to 120 volt AC power. The 120 volt AC power is then provided to speed controller 808. Speed controller 808 converts the 120 volt AC input to any of a range of desired direct current (DC) outputs. In one embodiment, the desired DC output is about 90 volts. The output of speed controller 808 is input to relay 716 (FIG. 4), whose operation has been previously described. Because speed controller 808 is capable of a variable DC output, the power supplied to conducting rails 218 (FIG. 4), and thus the speed of carriage 400 (not shown), may desirably be adjusted.

Note that the present invention contemplates within its scope any other circuits and/or systems that would provide the functionality of traverse direction control circuit 700 and/or speed control circuit 800 as disclosed herein. Such circuits are not limited solely to electrical or electronic circuits, and may include, but are not limited to, hydraulic control systems and their associated components.

Further, a variety of means may be employed to perform the function of moving the sensor package 502 along track 200. Carriage 400 and control system 1000 comprise an example of a means for performing that function. It should be understood that the embodiments of carriage 400 and control system 1000 are presented solely by way of example and should not be construed as limiting the scope of the present invention in any way.

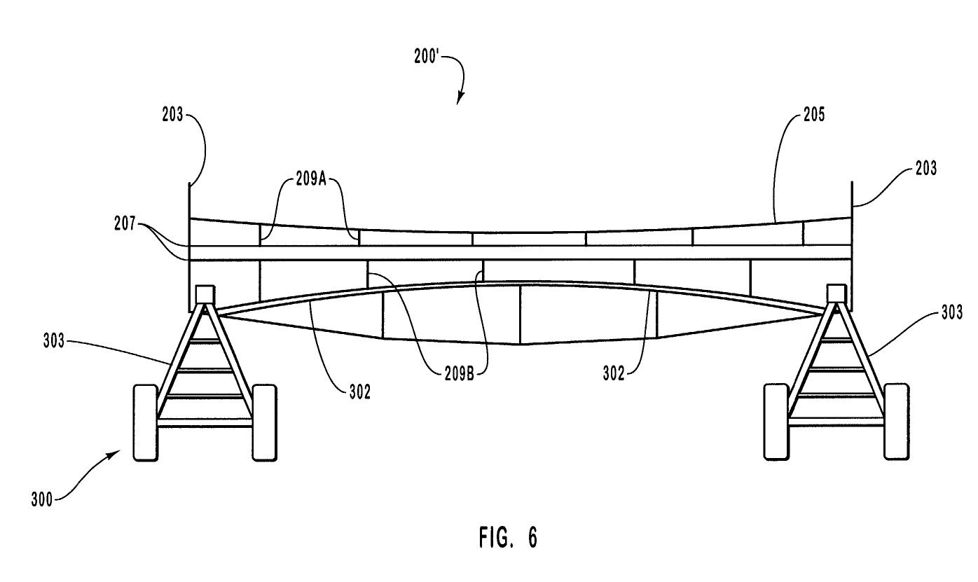

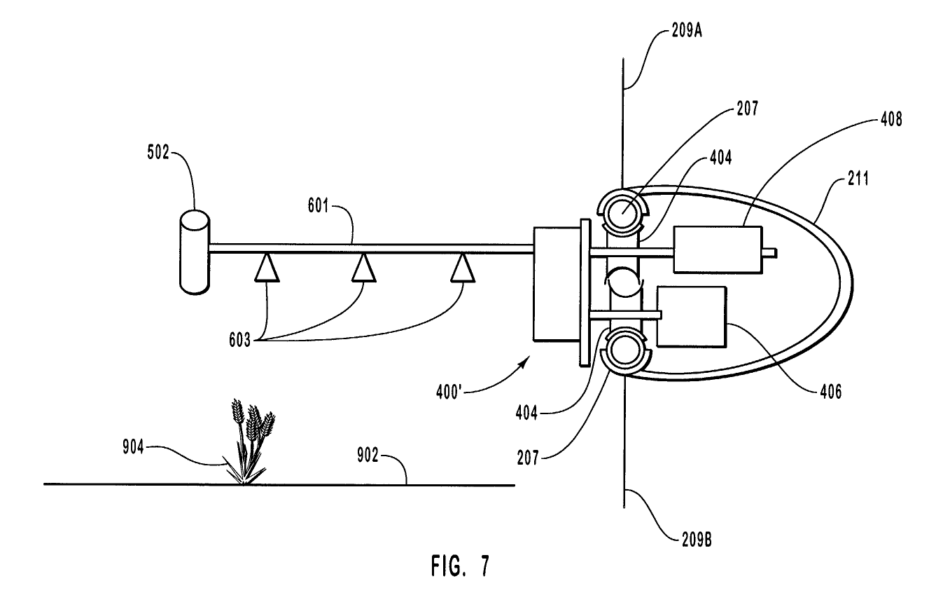

The foregoing discussion has focused on various aspects of a preferred embodiment of a ground based remote sensing system. Directing attention now to FIGS. 6 and 7, an alternative embodiment of a track 200 for use in ground based remote sensing system 100 is indicated generally at 200′. With reference first to FIG. 6, track 200′ includes a plurality of risers 203, one of which is attached to each tower 303 of a span of irrigation system 300, and a suspension cable 205 suspended between adjacent risers 203. Risers 203 preferably comprise structural aluminum shapes or the like. A plurality of rails 207 are suspended from suspension cable 205. In a preferred embodiment, two rails 207 are employed, at least one of which is made of aluminum or an aluminum alloy. However, it will be appreciated that other numbers of rails 207 could be profitably employed to provide the functionality of rails 207 as disclosed herein. As discussed below, rails 207 are preferably configured to conduct electricity, provided by speed control circuit 800, with one of the rails being ‘hot’, and the other functioning as a ground.

Sections of rail 207 of abutting spans of irrigation system 300 are joined by connectors 214′ and jumpers 216′ as indicated in FIG. 1A. Within each span of irrigation system 300, abutting sections of rail 207 are joined by couplers 210, as indicated in FIG. 1A. In this embodiment, couplers 210 are electrically conductive. A plurality of cables 209A are used to attach rails 207 to suspension cable 205. Elastic cables 209B connect rails 207 to main overhead pipe 302 of irrigation system 300 and facilitate vertical alignment and positioning of rails 207. Cables 209A and elastic cables 209B preferably comprise steel or the like. However, any other material that would provide the functionality, respectively, of the aforementioned cables, is contemplated as being within the scope of the present invention.

Directing attention now to FIG. 7, additional details of track 200′ are indicated. Rails 207 are connected to each other by way of clamps 211 or the like. Preferably, clamps 211 are C-shaped. Clamps 211 serve to maintain a desired distance between rails 207 so that carriage 400′ can readily travel along track 200′. Clamps 211 are electrically non-conductive or, alternatively, are insulated from contact with rails 207 so as to prevent short-circuiting of rails 207. Control system 1000, discussed elsewhere herein, serves to control the speed and direction of carriage 400′ along track 200′. Power is transmitted from control system 1000 to motor 406 of carriage 400′ by way of conducting wheels 404, which are in contact with rails 207.

As further indicated in FIG. 7, an alternative embodiment of carriage 400, indicated generally at 400′, is employed with track 200′. Carriage 400′ includes a counterweight 408 mounted for horizontal movement so as to counteract the rotational tendency imposed on carriage 400′ by sensor package 502, and thereby balance carriage 400′. Carriage 400′ also comprises a boom 601 from which sensor package 502 depends. Details regarding boom 601, sensor package 502, and mount 600 (used to attach sensor package 502 to boom 601-not shown in FIG. 7) are discussed elsewhere herein.

Note that, in one embodiment, a plurality of lights 603 are disposed along boom 601 so as to illuminate soil 902 and/or crops 904 and thereby facilitate data gathering during low light periods such as at night, or when atmospheric conditions such as clouds or dust are present. Alternatively, the plurality of lights 603 can be disposed on carriage 400′ and/or at the end of boom 601 in vertical alignment with sensor package 502. A plurality of lights 603 can be used to facilitate data gathering in at least one other way as well. In particular, employment of lights 603 with an intensity of approximately three (3) times the magnitude of solar radiation serve to cancel out the effect of solar radiation reflected by soil 902 and/or crops 904. In so doing, the plurality of lights 603 serve to eliminate errors in data gathering that are attributable to solar radiation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A ground based remote sensing system, comprising:
(a) at least one sensor;
(b) a mobile structure, said mobile structure transporting said at least one sensor along a desired pathway;
(c) means for moving said least one sensor substantially continuously along an axis bearing a predetermined relation to said desired pathway, said at least one sensor acquiring agricultural crop data as said at least one sensor moves along said axis and said desired pathway; and
(d) a data logger, said data logger recording said agricultural crop data acquired by said at least one sensor.

2. The ground based remote sensing system according to claim 1, wherein said means for moving said at least one sensor substantially continuously along an axis comprises a carriage, and speed and traverse direction control circuits, said axis being defined by a track depending from said mobile structure, and said carriage carrying said at least one sensor along said track in accordance with input from said speed and traverse direction control circuits.

3. The ground based remote sensing system according to claim 1, wherein said mobile structure comprises a linear move irrigation system.

4. The ground based remote sensing system according to claim 1, wherein said mobile structure comprises agricultural machinery.

5. The ground based remote sensing system according to claim 1, wherein said predetermined relation is substantially transverse.

6. The ground based remote sensing system according to claim 2, wherein said carriage comprises at least one boom attached thereto, said at least one sensor depending from said at least one boom, and said at least one boom removing said at least one sensor a predetermined distance from said mobile structure.

7. The ground based remote sensing system according to claim 6, wherein said at least one boom is rotatably attached to said carriage so that said at least one sensor depending from said at least one boom can be moved to a desired position.

8. A method for mapping an agricultural field, comprising the steps of:
(a) placing at least one sensor in operative communication with the agricultural field, said placing of said at least one sensor including at least the following steps:
(i) transporting said at least one sensor along a desired pathway, and
(ii) moving said least one sensor substantially continuously along on an axis substantially transverse to said desired pathway;
(b) acquiring agricultural crop data with said at least one sensor; and
(c) recording said agricultural crop data.

9. The method according to claim 8, wherein said transporting of said at least one sensor along a desired pathway and said moving of said at least one sensor substantially continuously along an axis substantially transverse to said desired pathway occur substantially simultaneously.

10. The method according to claim 8, wherein said acquiring of agricultural crop data comprises transmitting energy to the agricultural field and sensing energy transmitted by the agricultural field in response to said transmission by said at least one sensor.

11. The method according to claim 8, wherein said acquiring of agricultural crop data comprises sensing energy reflected by the agricultural field as a result of transmission of energy to the agricultural field by an external source.

12. The method according to claim 8, wherein said placing of said at least one sensor in operative communication with the agricultural field further comprises the step of disposing said at least one sensor in a substantially vertical orientation with respect to the agricultural field.

13. The method according to claim 8, wherein said acquiring of agricultural crop data comprises sensing energy emitted by the agricultural field as a result of transmission of energy to the agricultural field by an external source.

14. A system to position sensors for gathering agricultural crop data, comprising:
(a) at least two rails, said at least two rails being at least indirectly interconnected with each other so as to collectively form a track;
(b) a carriage, said carriage being mounted for movement along said track, the sensors being at least indirectly attached to said carriage; and
(c) means for moving said carriage along said track.

15. The system according to claim 14, further comprising a plurality of connectors, each of said plurality of connectors joining abutting rails so that ready movement of said carriage along said rails is not compromised by misalignment between said abutting rails.

16. The system according to claim 14, wherein said track comprises three rails.

17. The system according to claim 16, wherein said three rails are arranged to form a track with a triangular cross section.

18. The system according to claim 14, wherein said carriage comprises at least one boom attached thereto, the sensors depending from said at least one boom.

19. The system according to claim 18, wherein said at least one boom is rotatably attached to said carriage so that the sensors depending from said at least one boom can be moved to a desired position.

20. The system according to claim 14, further comprising means for transporting said track throughout an agricultural field.

21. The system according to claim 20, wherein said means for transporting said track throughout an agricultural field comprises an irrigation system.

22. The system according to claim 21, wherein said at least two rails depend from a suspension cable at least indirectly attached to adjacent towers of said irrigation system, and said at least two rails being at least indirectly attached to a main overhead pipe of said irrigation system.

23. The system according to claim 14, wherein said means for moving said carriage along said track comprises a control system.

24. The system according to claim 23, wherein said control system comprises a speed control circuit and a traverse direction control circuit.

25. The system according to claim 23, wherein said carriage further comprises a motor, said control system transmitting power to said motor so as to move said carriage along said track.

26. The system according to claim 25, further comprising a plurality of conducting rails, said control system transmitting power at least indirectly to said motor via said plurality of conducting rails.

27. The system according to claim 26, wherein said carriage comprises a first set of wheels supported by said track, and a set of conducting wheels in operative contact with said plurality of conducting rails so as to facilitate transmission of power from said control system to said motor.

28. The system according to claim 26, further comprising a plurality of electrically conductive connectors, each of said plurality of electrically conductive connectors joining abutting conducting rails so as to facilitate transmission of power from said control system through said abutting conducting rails to said motor and to accommodate relative movement between abutting conducting rails.

29. The system according to claim 25, wherein said at least two rails are electrically conductive, said control system transmitting power to said motor by way of said at least two rails.

30. The system according to claim 29, further comprising a plurality of electrically conductive connectors, each of said plurality of electrically conductive connectors joining abutting rails so as to facilitate transmission of power from said control system through said abutting rails to said motor and to accommodate relative movement between abutting rails.

31. A mount for attaching a sensor package to a mobile structure so as to position the sensor package to accurately and reliably gather agricultural crop data, comprising:
(a) a housing, said housing being removably secured to the mobile structure;
(b) a rotative couple, said rotative couple being mounted inside said housing; and
(c) a connecting rod, said connecting rod having a first end attached to said rotative couple and a second end attached at least indirectly to the sensor package.

32. The mount according to claim 31, further comprising an inclinometer, said inclinometer being mounted to the sensor package, and said inclinometer sensing and recording sensor package alignment data.

33. The mount according to claim 31, wherein said rotative couple comprises a ball interposed between a plurality of rings, compression exerted by said plurality of rings on said ball being variable by a plurality of adjustment screws.

34. The mount according to claim 33, wherein said plurality of rings comprise plastic, and said ball comprises metal.

35. A system to control movement of a carriage and attached sensors back and forth along a track:
(a) a speed control circuit;
(b) means for power transmission in operative communication with said speed control circuit, said speed control circuit providing power to said carriage via said means for power transmission so as to move said carriage along said track;
(c) means for limiting range of travel of said carriage; and
(d) a traverse direction control circuit in operative communication with said means for limiting range of travel of said carriage and said power source, said traverse direction control circuit controlling transmission of power from said speed control circuit to said carriage and causing said carriage to automatically stop and reverse direction when said carriage comes into operative communication with said means for limiting travel of said carriage.

36. The system according to claim 35, wherein said power comprises electrical power.

37. The system according to claim 36, wherein said means for limiting range of travel of said carriage comprises at least two limit switches.

38. The system according to claim 36, wherein said speed control circuit comprises a variable voltage output.

39. The system according to claim 36, wherein said means for power transmission comprises at least two conducting rails in operative communication with a motor of said carriage.

40. The system according to claim 36, further comprising a dynamic brake, said dynamic brake selectively preventing transmission of power from said speed control circuit to said means for power transmission.

41. The system according to claim 40, further comprising a signal interval/off delay timer in operative communication with said dynamic brake, said signal interval/off delay timer activating said dynamic brake for a user specified time interval.

42. A ground based remote sensing system, comprising:
(a) at least one sensor;
(b) a mobile structure, said mobile structure transporting said at least one sensor along a desired pathway;
(c) a carriage, said carriage carrying said least one sensor substantially continuously along an axis bearing a predetermined relation to said desired pathway, said axis being defined by a track at least indirectly attached to said mobile structure, said at least one sensor acquiring agricultural crop data as said at least one sensor moves along said axis and said desired pathway;
(d) a speed control circuit, said speed control circuit regulating the speed with which said carriage travels along said track;
(e) a traverse direction control circuit, said traverse direction control circuit automatically reversing direction of travel of said carriage when said carriage reaches a predetermined point along said track; and
(f) a data logger, said data logger recording said agricultural crop data acquired by said at least one sensor.

43. The ground based remote sensing system according to claim 42, further comprising at least two conducting rails, said at least two conducting rails transmitting power to a motor of said carriage in accordance with input from said speed control circuit and said traverse direction control circuit.

44. The ground based remote sensing system according to claim 42, wherein said track comprises at least two rails.

45. The ground based remote sensing system according to claim 44, wherein said at least two rails are electrically conductive, said speed control circuit transmitting power to said motor via said at least two rails.

46. The ground based remote sensing system according to claim 42, wherein said mobile structure comprises an irrigation system.

47. The ground based remote sensing system according to claim 46, wherein said track depends from a suspension cable at least indirectly attached to adjacent towers of said irrigation system, and said track being at least indirectly attached to a main overhead pipe of said irrigation system.

48. A ground based remote sensing system, comprising:
(a) at least one sensor;
(b) an irrigation system transporting said at least one sensor along a desired pathway;
(c) a carriage, said carriage carrying said least one sensor substantially continuously along an axis bearing a predetermined relation to said desired pathway, said axis being defined by an electrically conductive track having two rails at least indirectly attached to a suspension cable depending from adjacent towers of said irrigation system, said at least one sensor acquiring agricultural crop data as said at least one sensor moves along said axis and said desired pathway;
(d) a speed control circuit, said speed control circuit regulating the speed with which said carriage travels along said track;
(e) a traverse direction control circuit, said traverse direction control circuit automatically reversing direction of travel of said carriage when said carriage reaches a predetermined point along said track; and
(f) a data logger, said data logger recording said agricultural crop data acquired by said at least one sensor.

49. The ground based remote sensing system according to claim 48, further comprising at least one boom attached to said carriage, said at least one sensor depending from said at least one boom.

50. The ground based remote sensing system according to claim 49, further comprising at least one light depending from said at least one boom.
